(19) United States
(12) Patent Application Publication
(10) Pub. No.: US 2008/0102349 A1
(43) Pub. Date: May 1, 2008

(54) Membrane-electrode assembly having reduced interfacial resistance between catalyst electrode and electrolyte membrane

(76) Inventor: Ki Sub Lee, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,455

(22) Filed: Dec. 27, 2006

(30) Foreign Application Priority Data
Oct. 31, 2006 (KR) 10-2006-0106823

(51) Int. Cl. H01M 4/92

(52) U.S. Cl. 429/40

(57) ABSTRACT

The membrane-electrode assembly includes: a porous first catalyst electrode layer; a first gas diffusion layer which is coupled to a lower surface of the first catalyst electrode layer; a porous second catalyst electrode layer which is coupled to an upper surface of the first catalyst electrode layer; a conductive electrolyte solution which is coated with constant thickness between the first catalyst electrode layer and the second catalyst electrode layer and permeates into the first catalyst electrode layer and the second catalyst electrode layer, solvent thereof being evaporated so that a phase thereof is changed to a solid state so as to be closely attached to the first catalyst electrode layer and the second catalyst electrode layer, thereby forming the electrolyte membrane; and a second gas diffusion layer which is coupled to an upper surface of the second catalyst electrode layer.

### CROSS-REFERENCE TO RELATED APPLICATION

This application claims priority to and the benefit of Korean Patent Application No. 10-2006-0106823 filed in the Korean Intellectual Property Office on Oct. 31, 2006, the entire contents of which are incorporated herein by reference.

### FIELD

The present invention relates to a membrane-electrode assembly in which interfacial resistance between a catalyst electrode and an electrolyte membrane is reduced.

### BACKGROUND

A membrane-electrode assembly of a fuel cell includes a polymer electrolyte membrane, a gas diffusion layer, and electrodes (anode and cathode). Hydrogen supplied to the cathode is divided into a hydrogen ion and an electron. The hydrogen ion moves to the anode through the electrolyte layer and the electron moves to the anode through an external circuit. At the anode, the oxygen ion and the hydrogen ion react so as to generate water. Finally hydrogen and oxygen are coupled so as to generate electricity, water, and heat. There various components affecting on the performance of a membrane-electrode assembly (MEA) of a fuel cell. These important components include the performance of the polymer electrolyte membrane, interfacial resistance in the MEA, etc. Examples of a polymer electrolyte membrane include a hydrocarbon group membrane and a fluorine group membrane.

Most of the hydrocarbon group membranes are formed from carbon and hydrogen. The hydrocarbon group membrane is cheap and can be manufactured through a simple manufacturing process. However, the hydrocarbon group membrane has a drawback that it has a poor durability. Conversely, the fluorine group membrane, in which fluorine is contained in a polymer structure, is expensive and is manufactured through a complicated process. However, it has excellent durability and stability. For this reason, the fluorine group membrane is generally used as the MEA.

However, a single layer of the fluorine group membrane cannot be thin because of a problem encountered during the manufacturing process and a physical intensity. Generally as the thickness of the membrane increases, resistance of the membrane is increased and the performance of the MEA is deteriorated.

Accordingly, the MEA which can be easily manufactured and that has a small interfacial resistance would be highly desirable.

### SUMMARY

The present invention has been made in an effort to provide a membrane-electrode assembly having advantages of increased adhesive strength between a catalyst electrode layer and a polymer electrolyte membrane by increasing the contact area therebetween and having reduced interfacial resistance.

An exemplary embodiment of the present invention provides a membrane-electrode assembly including: a porous first catalyst electrode layer on which precious metal catalyst is coated; a first gas diffusion layer which is coupled to a lower surface of the first catalyst electrode layer so as to support the first catalyst electrode layer and evenly distribute gas; a porous second catalyst electrode layer which is coupled to an upper surface of the first catalyst electrode layer, with a precious metal catalyst coated thereon; a conductive electrolyte solution which is coated with a constant thickness between the first catalyst electrode layer and the second catalyst electrode layer and permeates into the first catalyst electrode layer and the second catalyst electrode layer, where a solvent thereof is evaporated so that a phase thereof is changed to a solid state so as to be closely attached to the first catalyst electrode layer and the second catalyst electrode layer, thereby forming the electrolyte membrane; and a second gas diffusion layer which is coupled to an upper surface of the second catalyst electrode layer so as to support the second catalyst electrode layer and evenly distribute the fuel gas.

The electrolyte solution may have a viscosity at which the electrolyte solution can be coated between the first catalyst electrode layer and the second catalyst electrode layer until the solvent thereof is evaporated. The first catalyst electrode layer and the first gas diffusion layer may be coupled to one another so as to form a gas diffusion electrode. A fixing frame which has equal height to that of the gas diffusion electrode may be coupled to both sides of the gas diffusion electrode so as to fix the gas diffusion electrode. The electrolyte solution may be nafion solution of about 20% by weight.

### BRIEF DESCRIPTION OF THE DRAWINGS

FIG. 1 is an exploded cross sectional view of a five-layer MEA.

FIG. 2 is a cross sectional view of a three-layer MEA.

FIG. 3 is a drawing showing a boundary of a membrane-electrode assembly.

FIG. 4 is a cross sectional view of a membrane-electrode assembly according to an exemplary embodiment of the present invention.

FIG. 5 is a schematic view showing process for forming a membrane-electrode assembly according to an exemplary embodiment of the present invention.

FIG. 6 is a drawing showing a boundary before and after coupling of an electrolyte solution and a catalyst electrode layer in a membrane-electrode assembly according to an exemplary embodiment of the present invention.

### DETAILED DESCRIPTION OF THE EMBODIMENTS

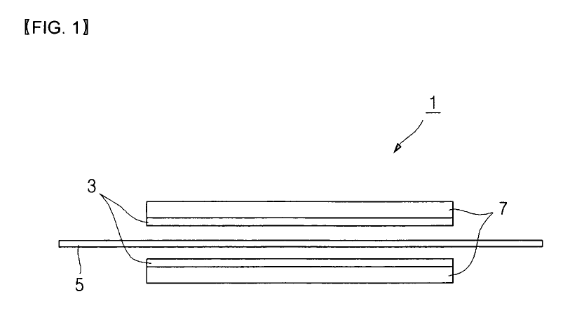

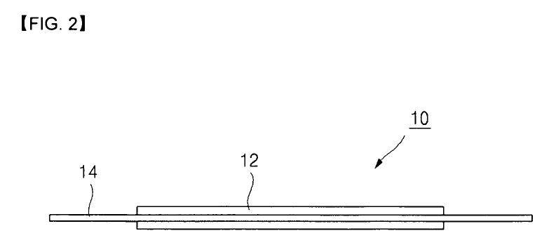

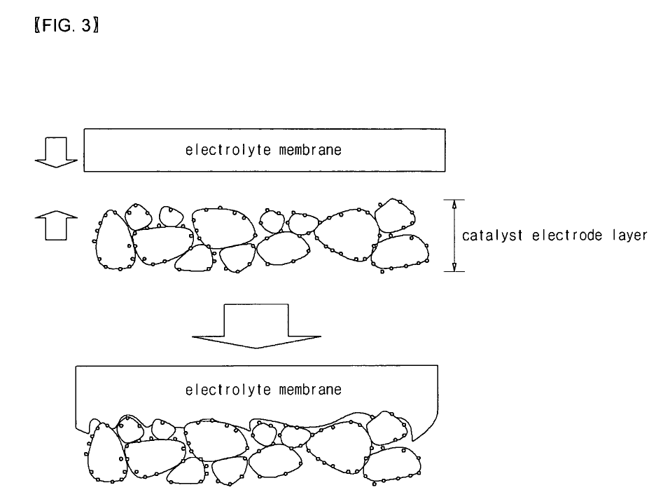

FIG. 1 is an exploded cross sectional view of a conventional five-layer MEA, FIG. 2 is a cross sectional view of a conventional three-layer MEA, and FIG. 3 is a drawing showing a boundary of a conventional membrane-electrode assembly.

As shown in FIG. 1 and FIG. 2, a membrane-electrode assembly may be divided into a five-layer MEA 1 and a three-layer MEA 10. Performance of the membrane-electrode assembly is affected by the number of layers thereof and resistance on a boundary layer between respective layers.

The five-layer MEA 1 can be more easily treated than the three-layer MEA, 10, but since the five-layer MEA 1 is manufactured by applying a hot press of a catalyst layer 3 in a solid layer and an electrolyte membrane 5 on a gas fusion layer 7, the contact area between the catalyst layer 3 and the electrolyte membrane 5 is small (referring to FIG. 3), and the interfacial resistance of the five-layer MEA 1 is relatively greater than that of the three-layer MEA 10.

The three-layer MEA 10 is manufactured by coating a catalyst electrode layer 12 on a separator by spraying, screen printing, or coating technique and then attaching the coated catalyst electrode layer 14 onto the electrolyte membrane 14 by pressing the electrolyte membrane at a high pressure and temperate.

Since such a decal method coats the catalyst electrode layer 12 on the separator, there is an advantage that deformation of the membrane, caused by solvent contained in slurry of catalyst, can be prevented. However, since the pressing process is added where the catalyst electrode layer 12 in a solid state from which solvent is removed is attached to the electrolyte membrane 14, there is a drawback that the contact area between the catalyst electrode layer 12 and the electrolyte membrane 14 is decreased so that interfacial resistance is increased (referring to FIG. 3).

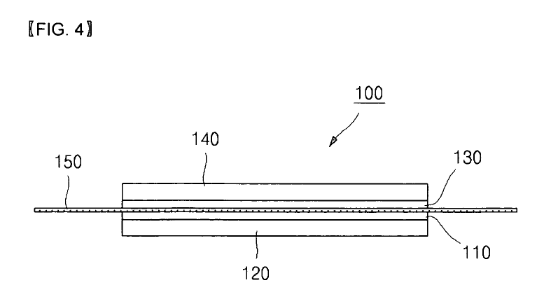

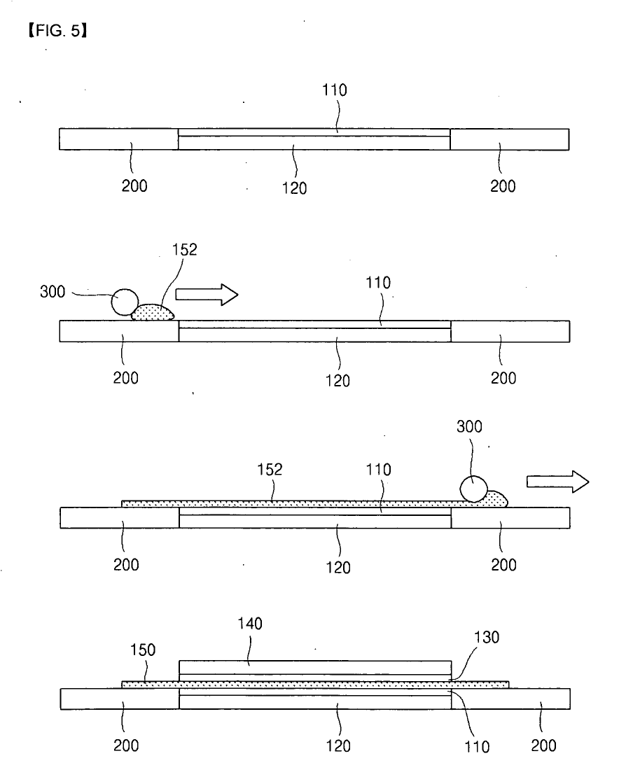

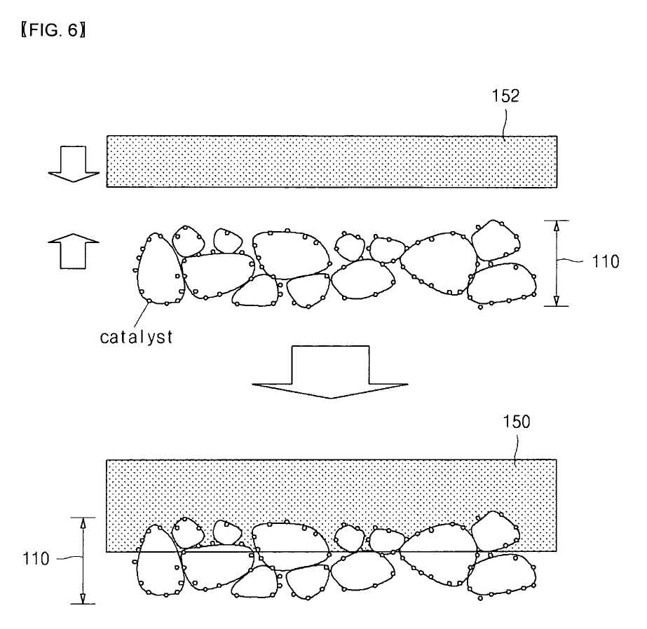

FIG. 4 is a cross sectional view of a membrane-electrode assembly according to an exemplary embodiment of the present invention. FIG. 5 is a schematic view showing the process for forming a membrane-electrode assembly according to an exemplary embodiment of the present invention. FIG. 6 is a drawing showing a boundary before and after coupling of an electrolyte solution and a catalyst electrode layer in a membrane-electrode assembly according to an exemplary embodiment of the present invention.

As shown in FIG. 4 to FIG. 6, in a membrane-electrode assembly (MEA; a “membrane-electrode assembly” and a “MEA” are used interchangeably hereinafter) 100 according to an exemplary embodiment of the present invention, a first gas diffusion layer 120 and a second gas diffusion layer 140 support a porous first catalyst electrode layer 110 and a porous second catalyst electrode layer 130. An electrolyte membrane 150 is interposed between the first catalyst electrode layer 110 and the second catalyst electrode layer 130. The MEA 100 is formed by coupling these members 110, 130, 120, 140 and 150 by pressing the same together.

As shown in FIG. 4, the first catalyst electrode layer 10 and the second catalyst electrode layer 130 are porous electrode layers (referring to FIG. 6), wherein a precious metal catalyst is coated thereon. One of them is an anode (oxidation electrode or fuel electrode) where hydrogen fuel is oxidized to split into a hydrogen ion and an electron. The other of them is a cathode (reduction electrode or air electrode) where oxygen is coupled with a hydrogen ion so as to form water. Electrons generated in this way move through the electrolyte membrane 150 to produce electrical energy.

The first gas diffusion layer 120 is coupled to a lower surface of the first catalyst electrode layer 110 so as to support the first catalyst electrode layer 110, and evenly diffuse the fuel gas. Similarly, the second gas diffusion layer 140 is coupled to an upper surface of the second catalyst electrode layer 130 so as to support the second catalyst electrode layer 130, and diffuse the fuel gas.

The electrolyte membrane 150 is interposed between the first catalyst electrode layer 110 and the second catalyst electrode layer 130 so as to serve as a passage through which electrons move. The electrolyte membrane 150 is made of an electrolyte solution 152.

The electrolyte solution 152 is a nafion solution of about 20% by weight, and may preferably have a high viscosity so as to maintain a constant thickness without spreading out or dripping off when being sprayed onto the first catalyst electrode layer 110.

As shown in FIG. 6, if the second catalyst electrode layer 130 is coupled after the electrolyte solution 152 with high viscosity is sprayed on, the electrolyte solution 152 permeates into the first catalyst electrode layer 110 and the second catalyst electrode layer 130 so that the contact area of a boundary surface is increased. In this state, if the solvent of the electrolyte solution 152 has dried, phase of the electrolyte solution 152 is changed to a solid state so as to form the electrolyte membrane 150. Since the electrolyte solution 152 is settled in a state of permeating into the first catalyst electrode layer 110 and the second catalyst electrode layer 130, adhesive strength between the first catalyst electrode layer 110 and the second catalyst electrode layer 130 and the electrolyte membrane 150 is increased. Accordingly, interfacial resistance is decreased.

The membrane-electrode assembly 100 according to an exemplary embodiment of the present invention is a five-layer MEA 100 having five layers and is manufactured through the following processes.

As shown in FIG. 5, the first catalyst electrode layer 110 and the first gas diffusion layer 120 are coupled so as to form a gas diffusion electrode (GDE). A fixing frame 200 is installed on both sides of the gas diffusion electrode so as to fix the gas diffusion electrode.

At this time, the height of the fixing frame 200 is equal to that of the gas diffusion electrode, and the electrolyte solution 152 is coated on an upper surface of the fixing frame 200 and an upper surface of the gas diffusion electrode, i.e., an upper surface of the first catalyst electrode layer 110.

Since the height of the fixing frame 200 is equal to that of the gas diffusion electrode, it is easy to coat the electrolyte solution 152 with a constant thickness.

Since the electrolyte solution 152 is a nafion solution of about 20% by weight and has a high viscosity, the electrolyte solution 152 can be coated with constant thickness while a casting knife 300 moves in the direction shown by the arrow. The thickness and area of the electrolyte solution 152 can be regulated according to the amount of pressing force of the casting knife 300.

After the electrolyte solution 152 is coated, the gas diffusion electrode, which is formed by coupling the second catalyst electrode layer 130 and the second gas diffusion layer 140, is laid on the electrolyte solution 152 and is then pressurized so as to attach the first catalyst electrode layer 110, the electrolyte solution 152, and the second catalyst electrode layer 130 together, thereby forming the five-layer MEA 100.

As shown in FIG. 6, the electrolyte solution 152 permeates into the first catalyst electrode layer 110 and the second catalyst electrode layer 130, so that they closely adhere to one another. In this state, if solvent of the electrolyte solution 152 is evaporated, the phase of the electrolyte solution 152 is changed to solid state to form the electrolyte membrane 150, and the electrolyte membrane 150, the first catalyst electrode layer 110, and the second catalyst electrode layer 130 are firmly coupled. That is, since the electrolyte solution 152 permeates into the catalyst electrode layers 110 and 130 so that the contact area is increased, interfacial resistance is decreased.

The five-layer MEA 100 which is manufacture in this way has considerably smaller interfacial resistance than the typical three-layer MEA 10 or five-layer MEA 1, so performance of the MEA can be substantially enhanced and performance of a fuel cell can be enhanced.

While this invention has been described in connection with what is presently considered to be practical exemplary embodiments, it is to be understood that the invention is not limited to the disclosed embodiments, but, to the contrary, is intended to cover various modifications and equivalent arrangements included within the spirit and scope of the appended claims.

As described above, in a membrane-electrode assembly having reduced interfacial resistance between a catalyst electrode layer and an electrolyte membrane, according to an exemplary embodiment of the present invention, a nafion solution in a liquid state is directly coated on the catalyst electrode layer and solvent of the solution is evaporated so as to be changed to a solid state. The contact area between the catalyst electrode layer and the polymer electrolyte membrane and adhesive strength therebetween are increased.

Accordingly, interfacial resistance can be decreased, so that performance of the MEA and the fuel cell can be enhanced.

What is claimed is:

1. A membrane-electrode assembly comprising:
a porous first catalyst electrode layer having a precious metal catalyst coating thereon;
a first gas diffusion layer coupled to a lower surface of the first catalyst electrode layer so as to support the first catalyst electrode layer and substantially evenly diffuse a fuel gas;
a porous second catalyst electrode layer coupled to an upper surface of the first catalyst electrode layer, the second catalyst electrode layer having a precious metal catalyst coated thereon;
a conductive electrolyte solution coated with a substantially constant thickness between the first catalyst electrode layer and the second catalyst electrode layer, and which permeates into the first catalyst electrode layer and the second catalyst electrode layer, wherein a solvent thereof is evaporated therefrom so that a phase thereof is changed to a solid state to be closely attached to the first catalyst electrode layer and the second catalyst electrode layer, thereby forming the electrolyte membrane; and
a second gas diffusion layer coupled to an upper surface of the second catalyst electrode layer so as to support the second catalyst electrode layer and substantially evenly diffuse the fuel gas.

2. The membrane-electrode assembly of claim 1, wherein the electrolyte solution has a viscosity at which the electrolyte solution can be maintained to be coated between the first catalyst electrode layer and the second catalyst electrode layer until solvent thereof is evaporated.

3. The membrane-electrode assembly of claim 1, wherein the first catalyst electrode layer and the first gas diffusion layer are coupled to one another so as to form a gas diffusion electrode, and a fixing frame which has equal height to that of the gas diffusion electrode is coupled to both sides of the gas diffusion electrode so as to fix the gas diffusion electrode.

4. The membrane-electrode assembly of claim 1, wherein the electrolyte solution is a nafion solution of about 20% by weight.
